(19) United States
(12) Patent Application Publication
(10) Pub. No.: US 2017/0097422 A1
(43) Pub. Date: Apr. 6, 2017

(54) METHOD AND SYSTEM FOR POSITIONING AND TIMING OF A RADIONAVIGATION RECEIVER

(71) Applicants: IGNACIO FERNANDEZ-HERNANDEZ, BRUSSELS (BE); KAI BORRE, GISTRUP (DK)

(72) Inventors: IGNACIO FERNANDEZ-HERNANDEZ, BRUSSELS (BE); KAI BORRE, GISTRUP (DK)

(21) Appl. No.: 15/315,861

(22) PCT Filed: Jul. 10, 2015
(86) PCT No.: PCT/EP2015/065882

§ 371 Date: Dec. 2, 2016

(30) Foreign Application Priority Data
Jul. 11, 2014 (GB) 1412351.7

(51) Int. Cl. G01S 19/42

(52) U.S. Cl. CPC G01S 19/42

(57) ABSTRACT

The present invention describes a method and a system to compute the time (t1) and the position (P1) of a receiver (102, 805, 901) based on satellite radiofrequency signals without accurate, a priori time or position information and without the need for demodulating data from the signals received by the satellites (103, 800). In particular, the present invention computes the receiver time (t1) and position (P1) by estimating the time offset between the actual time (t1) and an initial time (t0), which can be defined arbitrarily and even have an error of hours or days. The estimation of this time offset is performed by updating Doppler estimations (D(t0), D(t1)) between different times using Doppler change rates.

### FIELD OF THE INVENTION

The present invention relates to the technical field of radionavigation, and more particularly to methods and systems to compute the position and the time of a radionavigation receiver based on snapshot techniques.

### BACKGROUND OF THE INVENTION

Thanks mainly to the Global Positioning System (GPS), satellite navigation technologies, also called Global Navigation Satellite Systems (GNSS) technologies, have become ubiquitous. Currently, they are used in various devices and applications such as smartphones, personal navigation devices, vehicle guidance, machine control, and many others. Future devices may include miniaturised positioning ‘dots’ or stickers attached to a living being or object which are switched-on on request or sporadically due to a given event.

A standard standalone GPS receiver estimates the time-of-arrival (TOA) of signals transmitted from satellites and computes the satellites' positions extracting the signals' data. First, it acquires the signals and measures their frequencies (Doppler values) and delays (code phases) by correlating signal replicas with the received signals. Afterwards, it locks to the signals with dedicated tracking loops and starts demodulating the data contained therein. Since the receiver has a priori no synchronisation with the signals, it has to demodulate the signals' data until a certain pattern is found (the so-called TLM, or telemetry, in the GPS signal). After this pattern is found, the receiver can synchronise and can start interpreting the data. This first includes the satellite time reference called Time of Week and Week Number (TOW and WN) and then the satellite ephemerides, which allow computing the satellites' positions and the satellites' clock offsets. Once data is demodulated and the TOA is estimated for at least four satellites, the receiver is able to compute a 3D position and its time offset. While the satellites are accurately synchronised to a time reference, the receiver is a priori not. This whole process may take between 30 seconds and 1 minute for standard receivers until a first position fix is obtained.

Assisted GNSS involve techniques to improve receiver functionality and performance through an assisted communication channel. The book “A-GPS, Assisted GPS, GNSS and SBAS”, van Diggelen, 2009, thoroughly describes the field of Assisted GPS or Assisted GNSS by presenting several techniques to improve time-to-fix and sensitivity. These techniques are based on the existence of a communication channel between the receiver and a server that enables the server to compute the receiver position or to transmit the satellite ephemerides to the receiver so as to allow a faster, almost instantaneous, fix.

Assisted techniques, as implemented in mobile phones or smartphones, generally assume the synchronisation of the receiver through a wireless network down to a few seconds. They also encompass the transmission of a position and a time reference to facilitate the acquisition process. Assisted techniques can therefore provide an almost instantaneous positioning and timing without the need for decoding satellite data. However, they usually require an initial receiver position with an error of maximum some kilometres and an initial receiver time with an error of maximum some seconds.

U.S. Pat. No. 5,663,734 A, “GPS receiver and method for processing GPS signals”, discloses an apparatus for the storage of a snapshot of digital samples and the associated methods to process this snapshot. While the receiver does not need to demodulate the data from the satellites, U.S. Pat. No. 5,663,734 A does not disclose how to solve high time synchronisation and position errors.

U.S. Pat. No. 7,987,048 B2, “Method and apparatus for computing position using instantaneous Doppler measurements from satellites”, discloses a method based on a receiver-plus-server architecture where Doppler measurements are combined with code phase or pseudorange measurements for positioning. Doppler measurements are used to compute an initial receiver position with an accuracy of some kilometres, which can later be used as a reference for a more accurate position using pseudorange measurements. However, this initial receiver position calculation requires an initial receiver time, which has to be accurate to the level of few minutes. Thus, this method does not solve the problem of calculating a position where the time uncertainty is beyond a few minutes, e.g., in the order of hours or days.

Hence, there is a long-felt need in the technical field of radionavigation of overcoming the abovementioned drawbacks of the state-of-the-art solutions.

### OBJECTS OF THE INVENTION

The first object of the invention is to provide an improvement to the state-of-the-art. The second object of the invention is to solve the aforementioned drawbacks of the prior art by determining the position and the time of a radionavigation receiver without the need for demodulating satellite data and without an accurate initial receiver position and an initial receiver time.

### DESCRIPTION OF THE INVENTION

The aforementioned objects of the invention are achieved by a method for calculating an actual time and an actual position of a radionavigation receiver by using satellite radiofrequency signals, wherein the method comprises:

providing an initial receiver time, an initial receiver position and satellite position data;

receiving said signals by said receiver and computing from said received signals Doppler measurements between said satellites and said receiver;

estimating Doppler values and Doppler change rates between said satellites and said receiver at the initial receiver time and at the initial receiver position by means of said satellite position data;

computing Doppler values between said satellites and said receiver at the actual receiver time;

calculating a time difference between the actual receiver time and the initial receiver time by computing a subtraction of the Doppler values at the initial receiver time from Doppler values at the actual receiver time and dividing said subtraction by the Doppler change rates; and

calculating the actual receiver position by means of the calculated actual receiver time.

The abovementioned “satellite position data” refers to satellite information that allows computing a satellite position at given times. It may refer, for example, to satellite ephemerides or almanacs expressed in Keplerian orbital parameters, satellite instantaneous positions at given times, satellite positions, velocities and accelerations, or any other information enabling calculating where a satellite was located during a certain time interval.

The Doppler measurements between the satellite and the receiver are usually computed from the estimation of the satellite signal frequency from the receiver, which will be different from the expected frequency carrier due to the relative movement of the satellite from the receiver, causing Doppler effect. Doppler measurements are therefore an indicafor of the satellite-to-receiver range rate. Equivalent measurements leading to the same results would be those using differences in the pseudorange, code phase measurement or carrier phase measurement at different times.

The estimated Doppler values can be obtained by calculating the relative velocity of the satellite at the initial receiver time, which can be extracted from the satellite position data with respect to the receiver at the initial position. The estimated Doppler change rates can be obtained by differentiating the Doppler values in time by calculating the difference in the Doppler values at two time instants and dividing by the time. Doppler change rates are equivalent to range rate change rates or satellite-to-receiver accelerations.

The time difference between the actual receiver time (t1) and the initial receiver time (t0) of the receiver can be estimated by the formula t1−t0 ≈(D1−D0)/a, where D1 is the measured Doppler for a satellite, D0 is the estimated Doppler at t0 for the same satellite and a is the Doppler change rate, which expresses the satellite acceleration magnitude as seen from the receiver.

Once the time difference (t1−t0) is calculated, the actual receiver time t1 is consequently derivable, and the actual receiver position can be estimated through, for example, Doppler positioning techniques.

The main advantage of the invention with respect to the prior art is that it allows calculating the time and the position of a receiver without requiring accurate initial receiver timing or position information and the demodulation of satellite signal data. In particular, it solves the problem of instantaneous Doppler positioning methods when the initial receiver time is inaccurate by more than a few minutes. Thanks to this invention, a receiver can calculate its actual time and its actual position with a signal snapshot almost instantaneously, even if both the initial receiver time and the initial receiver position are unknown. All prior art methods require, instead, either an initial receiver time that is better than two minutes or the calculation of a position at intervals separated by one minute and then the extraction of the best estimate.

There is prior art that proposes to use Doppler change rates or satellite-to-receiver relative accelerations in aspects related to radionavigation, but all of the proposed uses relate to developments in signal tracking to generate better measurements or to improve the demodulation of the signal's data. The present invention relates, instead, to the calculation of the navigation solution from existing satellite measurements and, since it is based on snapshot techniques, it does not require demodulating any signal's data. In fact, no prior art has been found that discloses a method to calculate a receiver's position and time from Doppler measurements, where the initial receiver time is unknown by more than some minutes and Doppler change rate estimations are used in the calculation.

Note that the last two steps of the method do not necessarily need to be carried out in the order described above but may also be performed simultaneously through adding the time difference (t1−t0) as an additional unknown to the instantaneous Doppler equations.

The invention also applies where instead of satellites transmitting radiofrequency signals the radiofrequency transmitters are ground base stations or static/dynamic beacons for which the Doppler change rate between the receiver and the transmitter due to the movement of any of the two during a time interval can be estimated.

In an advantageous embodiment of the invention, the steps of calculating the time difference and the actual receiver position are performed iteratively. In this case, the estimation of the time offset (t1−t0) and the position of the receiver are repeated until they converge to values after which new estimations do not change the result, thus minimising the error.

In an advantageous embodiment of the invention, said initial receiver position is any arbitrary position on the Earth surface or the Earth centre or a position based on satellite ground track points at said initial receiver time. Hence, the initial receiver position can be arbitrary and therefore does not need to be known by the receiver.

In an advantageous embodiment of the invention, said Doppler measurements are computed from satellites with different orbital periods. If only one constellation is used, a plausible time and position solution can be obtained with a fixed periodicity, which is close to 12 hours in the case of GPS. To resolve this problem, measurements from at least two satellites, each from a different satellite constellation, e.g., GPS, GLONASS, Galileo or Beidou, and with a different orbital period can be used to avoid the periodic repeatability of Doppler values from satellites from a single constellation leading to multiple plausible solutions. In this embodiment, the Doppler repeatability period will correspond to the minimum common multiple of the orbital periods of the satellites used.

In an advantageous embodiment of the invention, said Doppler measurements are obtained from said signals by computing the Doppler frequency shift or the code phase difference between two time instants or the carrier phase difference between two time instants.

In an advantageous embodiment of the invention, the method further comprises computing range measurements and/or code phase measurements from said signals and estimating a final receiver time and a final receiver position by means of said measurements, wherein the measurements are initialised by the calculated actual receiver time and actual receiver position. As the Doppler time and position solution may be less accurate than a solution based on TOA measurements, solving the time ambiguity associated to code phase measurements by using the receiver time and position calculated from the Doppler measurements as the initial receiver time and the initial receiver position improves the accuracy of the estimated actual receiver time and the estimated actual receiver position.

In an advantageous embodiment of the invention, the method further comprises computing a plurality of initial receiver times within a time uncertainty interval (e.g., several days) and calculating the actual receiver time and the actual receiver position for each of said initial receiver times. In another advantageous embodiment of the invention, the method further comprises determining the validity of each calculated actual receiver time by means of an indicator based on the residuals of said measurements (i.e., the difference between the Doppler measurements and the Doppler estimations at the calculated actual receiver time and actual receiver position) with respect to the calculated actual receiver position. In yet another advantageous embodiment of the invention, the method further comprises determining the validity of each calculated actual receiver time by means of an indicator based on the height of the calculated actual receiver position. While the previous embodiments enable calculating the receiver's position with an initial receiver time error of up to a few hours depending on the satellite-to-receiver geometry, these embodiments enables calculating the receiver's position at several few-hour intervals and then extracting the best estimate based on, e.g., the magnitude of the residuals or the height of the receiver's position. For instance, in the latter case, all the positions at a height not consider plausible (e.g., far above the earth surface for a terrestrial receiver) are discarded.

In an advantageous embodiment of the invention, the steps of calculating the time difference and the actual receiver position are performed by relating said Doppler measurements to a vector of unknowns through a non-linear system of equations and solving the system of equations iteratively, wherein the vector includes a receiver position vector, a receiver velocity vector, a receiver frequency clock drift and a coarse time difference between the initial receiver time and the actual receiver time.

This embodiment tackles the case when the receiver is not static by solving a system of non-linear equations including the receiver velocity components. The detailed equations that relate the state vector with the Doppler measurements are defined in the section: “Preferred embodiments of the invention”.

In an advantageous embodiment of the invention, at least one component of said vector is zero or is determined by an estimation of the height with respect to the Earth surface, an inertial unit, an odometer or an external time/frequency source (e.g., an external reference server connected to the receiver through a communication channel). By reducing the number of unknowns, the number of Doppler measurements required to calculate the receiver position is also reduced.

Also, the aforementioned objects of the invention are achieved by a system for calculating an actual time and an actual position of a radionavigation receiver by using satellite radiofrequency signals, wherein the system comprises a radionavigation receiver (e.g., including an antenna, a receiver front end, a memory unit and a processing unit) and a plurality of satellites, wherein:

said receiver is adapted to receive said signals (e.g., thanks to the antenna and the front end) and to compute from said received signals Doppler measurements between said satellites and said receiver (e.g., the receiver front end may convert said radiofrequency signals into streams of digital samples and the processing unit may compute Doppler measurements from said streams of digital samples);

said receiver is adapted to provide an initial receiver time, an initial receiver position and satellite position data (e.g., the memory unit may store and provide satellite position data to the processing unit, which computes at least one initial receiver time and at least one initial receiver position);

said receiver (e.g., the processing unit) is adapted to estimate Doppler values and Doppler change rates between said satellites and said receiver at the initial receiver time and at the initial receiver position by means of said satellite position data;

said receiver (e.g., the processing unit) is adapted to compute Doppler values between said satellites and said receiver at the actual receiver time;

said receiver (e.g., the processing unit) is adapted to calculate a time difference between the actual receiver time and the initial receiver time by computing a subtraction of the Doppler values at the initial receiver time from Doppler values at the actual receiver time and dividing said subtraction by the Doppler change rates; and

said receiver (e.g., the processing unit) is adapted to calculate the actual receiver position by means of the calculated actual receiver time.

In an advantageous embodiment of the invention, said receiver is further adapted to store (e.g., by means of the memory unit) at least one digital snapshot of samples of said signals and to calculate (e.g., by means of the processing unit) at least one actual receiver time and at least one actual receiver position at a scheduled time (e.g., at a later stage with respect to the storage of the snapshot). This implies that one or several snapshots can be recorded and not processed until a later stage. Since the invention allows solving high time uncertainties, there is no need to time-tag the snapshots when they are recorded.

In an advantageous embodiment of the invention, the system further comprises a server, the receiver being further adapted to send said snapshot to the server (e.g., by means of a wireless transceiver), which server (e.g., by means of a processing unit) is adapted to determine at least one actual receiver time and at least one actual receiver position according to the method as described above. This implies that the receiver can function autonomously and be powered up sporadically for generating and storing said digital snapshots, thus using low power during long periods of time.

Advantageously, the steps of calculating the time difference and the actual receiver position are performed iteratively.

Advantageously, said initial receiver position is any arbitrary position on the Earth surface or the Earth centre or a position based on satellite ground track points at said initial receiver time.

Advantageously, said Doppler measurements are computed from satellites with different orbital periods.

Advantageously, said Doppler measurements is obtained from said signals by computing the Doppler frequency shift or the code phase difference between two time instants or the carrier phase difference between two time instants.

Advantageously, said receiver is adapted to compute range measurements and/or code phase measurements from said signals and estimate a final receiver time and a final receiver position by means of said measurements, wherein the measurements are initialised by the calculated actual receiver time and actual receiver position.

Advantageously, said receiver is adapted to compute a plurality of initial receiver times within a time uncertainty interval and calculate the actual receiver time and the actual receiver position for each of said initial receiver times.

Advantageously, said receiver is adapted to determine the validity of each calculated actual receiver time by means of an indicator based on the residuals of said measurements with respect to the calculated actual receiver position.

Advantageously, said receiver is adapted to determine the validity of each calculated actual receiver time by means of an indicator based on the height of the calculated actual receiver position.

Advantageously, said receiver is adapted to calculate the time difference and the actual receiver position by relating said Doppler measurements to a vector of unknowns through a non-linear system of equations and solving the system of equations iteratively, wherein the vector includes a receiver position vector, a receiver velocity vector, a receiver frequency clock drift and a coarse time difference between the initial receiver time and the actual receiver time.

Advantageously, at least one component of said vector is zero or is determined by an estimation of the height with respect to the Earth surface, an inertial unit, an odometer or an external time/frequency source.

Advantageously, said receiver is a portable localisation device comprising an antenna, a front end, a memory unit and a processing unit.

Advantageously, said portable localisation device is embedded in a miniaturised device adapted to be attached or tagged to objects, animals or human beings.

Advantageously, said portable localisation device further comprises a sensor unit adapted to provide information about the motion and/or the velocity of the portable localisation device. This information can be valuably used by the processing unit in the calculation of the actual receiver time and the actual receiver position.

Advantageously, said sensor unit comprises one or more physical and/or biometric sensors for relating said snapshot data to data from said physical and/or biometric sensors.

Note that all the aforementioned advantages of the method are also met by the system.

The use of a system as described above for road tolling or for tracking animals, people or portable objects (whereby the position information can be related to data from physical or biometric sensors).

Applications of the proposed invention mainly relate to snapshot receivers that do not have an accurate time reference at the time the snapshots are captured such as small and low-power tracking devices for animals or containers that are powered up sporadically.

The invention can also be suitable for applications such as road tolling and mobile location. These applications may have a time reference available, which may be sometimes wrong. The invention is useful to make the positioning process independent from any external synchronisation source.

### BRIEF DESCRIPTION OF THE DRAWINGS

Preferred embodiments of the invention will now be described, by way of example, with reference to the following accompanying drawings, where:

FIG. 1 is a schematic illustration of a satellite Doppler variation over time, as seen from a receiver.

FIG. 2 is a schematic illustration of the relationship between the Doppler value and the Doppler change rate.

FIG. 3 depicts a flow diagram of an exemplary embodiment of a method according to the present invention for determining position and timing.

FIG. 4 is a schematic illustration of an example situation with a time uncertainty period, where a solution for several initial time references is computed and satellites with identical orbital periods are used.

FIG. 5 is a schematic illustration of an example situation with a time uncertainty period, where a solution for several initial time references is computed and satellites with different orbital periods are used.

FIG. 6 depicts a flow diagram of an exemplary embodiment of a method according to the present invention for determining position and timing from previously obtained Doppler-based solutions.

FIG. 7 is a schematic illustration of an example situation where Doppler-based plausible solutions are used as initialisation for pseudorange-based solutions.

FIG. 8 depicts a block diagram with an exemplary embodiment of a positioning system based on the present invention.

FIG. 9 depicts a block diagram with another exemplary embodiment of a positioning system according to the present invention.

### PREFERRED EMBODIMENTS OF THE INVENTION

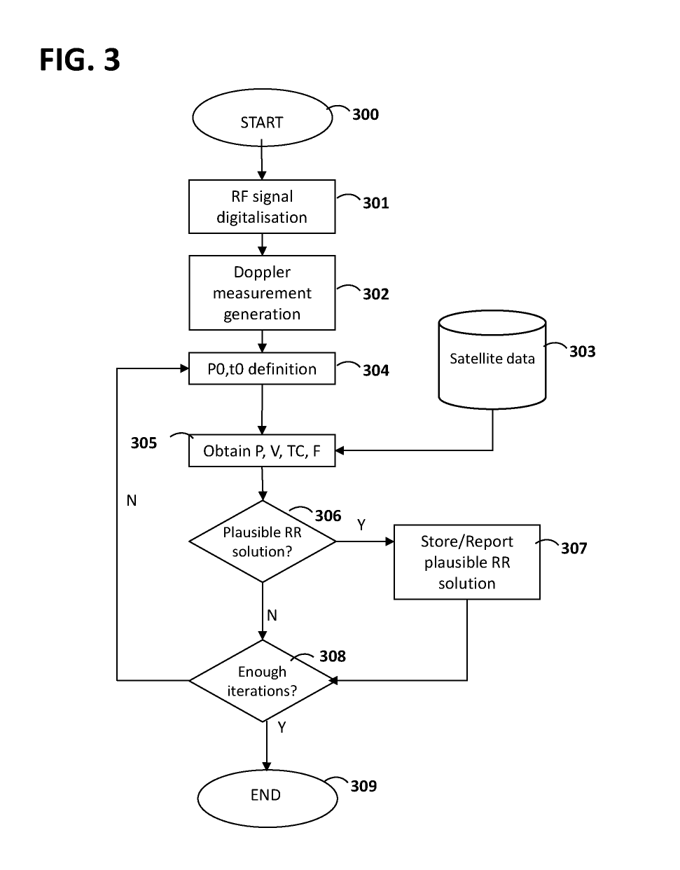

A description of a preferred embodiment of the invention will be now discussed, following the diagram depicted in FIG. 3. After the start of the method in step 300, a receiver receives at least one radiofrequency signal stream containing the satellite signals later used for positioning and it filters, amplifies, synthesises and digitises the signal stream as in a standard receiver radiofrequency front end, as represented in step 301, to generate digital samples containing the satellite signals.

In the following step 302, the present invention requires the processing of said digital samples to obtain the Doppler measurements between said satellites and said receiver. In the case of GPS and GNSS signals, this usually requires a signal acquisition engine which correlates the digital samples with replicas of the signals spreading codes. As an outcome of the acquisition stage, measurements for each satellite of the satellite-to-receiver Doppler and range can be obtained. It should be noted that Doppler measurements can be obtained from frequency Doppler measurements as well as code phase difference measurements or carrier phase difference measurements at two time instants.

The present invention requires the knowledge of the satellite position data 303, including satellite positions over the time uncertainty interval. If the satellite's clock drift impact is non-negligible, it could be used as well as part of the satellite position data. In standard receiver architectures, the receiver decodes this information from the data modulated on the satellite signal (50 bps in GPS L1 C/A signals), a process which may last at least 30 seconds in good reception conditions for each satellite. In the present invention, this data is not demodulated but obtained from another source. As a person skilled in the art can appreciate, this source can be: previously demodulated ephemerides from the signals, satellite data downloaded from a server, long term orbital predictions from the satellites, satellite almanac data, which provides long term satellite orbits with a precision of some kilometres and which can be a valid source depending on the accuracy desired for the position to be calculated, or other sources. These data can be formatted in standard orbital Keplerian parameters that can be interpolated to a given time reference, satellite position, velocity and acceleration models, or other formats, as long as they allow the estimation of the satellite positions at a given time.

In addition to the satellite position data, the present invention requires the definition of an initial receiver time t0 and initial receiver position P0 304. The position P0 can be set to the Earth centre, or the centre of the polygon formed by the satellite ground track at t0 for the observed satellites. The initial reference t0 can differ from the actual measurement time in a few hours, depending on the satellite-receiver geometry. If the time error is in the order of hours, one computation may be sufficient. If the time error is higher, several computations with different time references over the uncertainty interval may be required, as described later in other preferred embodiments of the invention. In any case, in prior art references, a snapshot position can be calculated only if the time reference error is below one or a few minutes. While this is the standard use case for handheld or car devices which are synchronised through a network or which have a contenuously running clock used as a time reference, the existence of an initial time reference with an accuracy of some minutes cannot be assumed for any localisation device. For example, a GPS tracker attached to an animal or an object, which is not connected to a server and does not include an internal accurate clock reference. The present invention, instead, can determine a position with a much highly relaxed time reference.

For a given position and time pair (P0, t0), the receiver position, velocity, timing and frequency drift are obtained in the following step 305 by resolving a system of equations that relates the Doppler measurements to the receiver position, velocity and time. In this embodiment, the receiver does not assume that the receiver is static or its velocity can be neglected, and therefore the unknowns are the position (P1), velocity (V1), frequency drift (F) and the time difference (TC) between said time reference t0 and the actual measurement time t1. Satellite-to-receiver Doppler measurements represent the satellite velocity relative to the receiver. The method estimates the Doppler at a different time by estimating the satellite-to-receiver accelerations (or Doppler change rates, or time derivative of the satellite-to-receiver velocities) at the initial time t0.

In this embodiment, a receiver three-dimensional position and velocity, frequency drift and timing offset need to be solved with the proposed state vector:

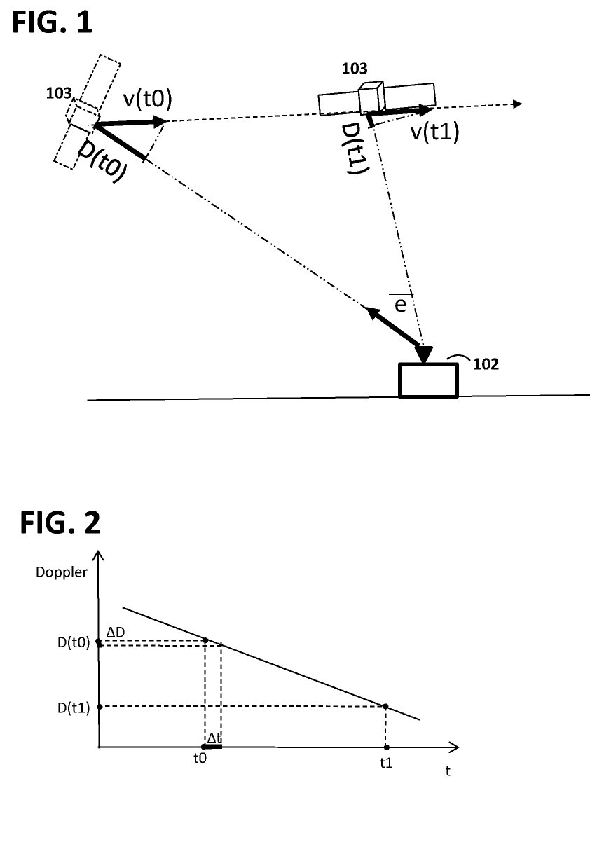

X=(x, y, z, vx, vy, vz, fc,tc)

where x, y and z are the receiver coordinates (P1), vx, vy and vz are the receiver velocity coordinates, fc is the receiver clock frequency drift, and tc is the time difference between the initial time t0 and the actual time t1. A person skilled in the art will note that Cartesian coordinates (x, y, z) can be replaced by coordinates in another reference system, as for example latitude-longitude-height (LLH), or North-East-Down (NED), as long as the matrix of measurements observations (H) represents the system of equations, or the linearised equations, that relate the measurements with the state vector. In the present embodiment, the proposed system of equations is:

$$δ D = [ \begin{matrix}- {{e}^{′}}^{i} & - {e}^{i} & 1 & {a}^{i}\end{matrix} ] [ \begin{matrix}δ x \\ δ y \\ δ z \\ δ vx \\ δ vy \\ δ vz \\ δ fc \\ δ tc\end{matrix} ] + ɛ$$

where: δD corresponds to the vector of the differences between the Doppler measurements and the Doppler value estimations from the satellite position data and a previous position and time, which for the first iteration is set to P0 at t0, −e′ⁱ is the derivative in time of the estimated receiver-to-satellite-i unitary vector with the opposite sign −eⁱ, which is shown in FIG. 1 as ē, aⁱ is the satellite-i-to-receiver acceleration, and ε is the error associated to the measurements and the linearization process. This system of equations can be obtained by the differentiation with respect to time of the equations of a system to determine the coarse time navigation five unknowns x, y, z, b and tc with pseudorange measurements, being b the receiver clock bias.

With this system of equations, coarse time Doppler positioning can be performed. This means that a position and time in the order of a few kilometres of accuracy and some milliseconds of bias can be determined.

The abovementioned system of equations can be solved by a standard iterative process, whereby the δD and the state vector δx, δy, δz, δvx, δvy, δvz, δf c, δtc provide an update to the previous iteration.

FIG. 1 and FIG. 2 depict geometrically the principles of the proposed invention. In particular, FIG. 1 depicts, for the case of one satellite 103 and a receiver 102, the estimated range rate or Doppler D(t0) at time t0 and the measured range rate or Doppler D(t1) at time t1 between said satellite and receiver. It also depicts the estimated unitary vector e. Satellite-to-receiver Doppler at an instant t0 D(t0) and at an instant t1 D(t1) between a satellite 103 and a receiver 102 differ by a magnitude that can be approximated by the time increment between t1 and t0 multiplied by the satellite-to-receiver relative acceleration, or Doppler change rate.

FIG. 2 depicts how the satellite-to-receiver acceleration can be estimated as the time derivative of the Doppler value, that is, the increment in Doppler value (ΔD) divided by the increment in time Δt (a=ΔD/Δt). It also depicts how this acceleration relates the estimated Doppler value at t0 with the actual or measured Doppler value at t1 according to the formula D(t1)≈D(t0)+(t1−t0)·α, where D is the range rate or Doppler and a is the time variation of the range rate, or Doppler change rate, or satellite acceleration relative to the receiver. The time difference between the actual receiver time (t1) and the initial receiver time (t0) of the receiver can be estimated by the formula t1−t0≈(D(t1)−D(t0))/α.

The proposed method therefore allows the calculation of a coarse position and timing estimation without, or with an arbitrary, initial position and time reference. A person skilled in the art can observe that the calculated position and time P1 and t1 may have an accuracy of some kilometres and milliseconds respectively, due to the error in the instantaneous Doppler measurement estimation by the receiver. If a position with a higher accuracy needs to be obtained, existing methods can use this initial position and time for a coarse time navigation solution using pseudorange measurements as described in prior art, allowing an accuracy in the meter-level. Another embodiment of the proposed invention uses this combination.

A person skilled in the art can also observe that the Doppler function is not always linear over time, and therefore the acceleration is not constant, as approximated here. The proposed approximation is however valid for time intervals of up to at least three hours, and possibly more, depending on the satellite to receiver geometry. Common methods of linearization of non-linear equations like Taylor series where only the first order partial derivative is used, as commonly used in satellite navigation equations, are valid in this approach. A person skilled in the art can also observe that the Doppler measurement will depend on the satellite clock frequency drift. This drift can be added to the measurement estimation or neglected in the case of navigation satellites with highly stable atomic clocks. A person skilled in the art can also appreciate that the estimation of the acceleration can also be taken from the satellite position data and can further be refined by adding a linear time-varying components, as jerk (i.e., the time-derivative of acceleration), or higher order components, so as to refine the Doppler estimation at a different time and improve the convergence period.

A check is performed to assess if the obtained Doppler-based (or range-rate based) solution P1, t1 is considered plausible 306, meaning that it is near the Earth surface and any standard integrity check related to the solution measurement residuals does not show any anomaly. If this is the case, the solution is stored for later use and reported as an output of the method 307.

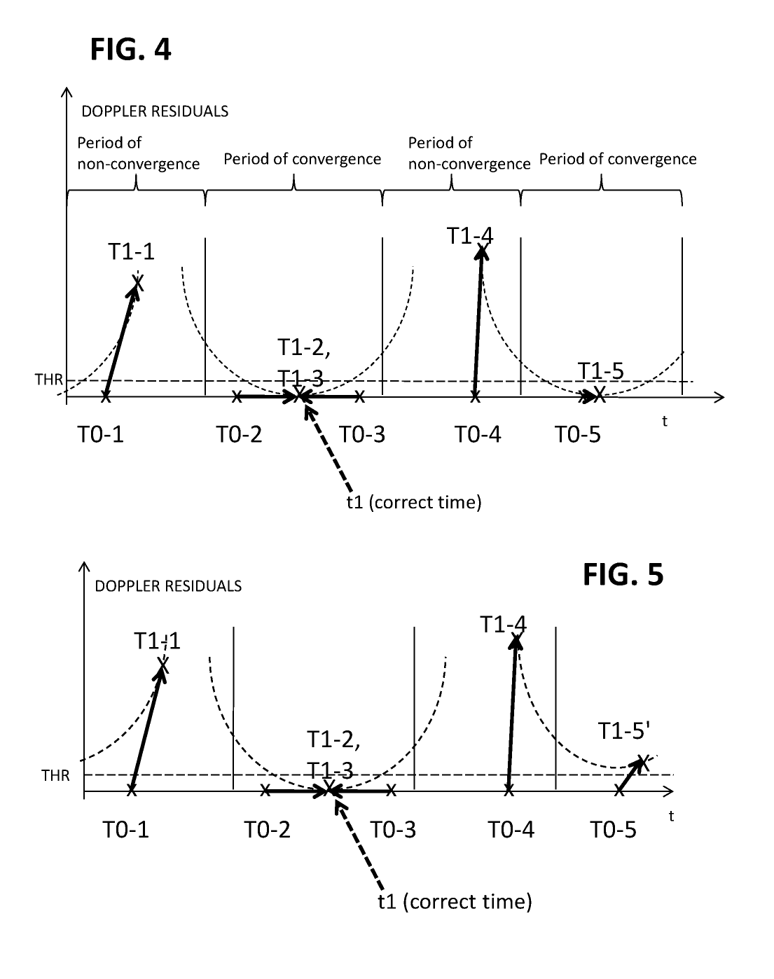

As it will be described more in detail in another embodiment of the present invention, several iterations with different initial times can be performed in step 308 of FIG. 3, and as shown in more detail in FIG. 4. In an embodiment of the invention, only one iteration is performed. After the process of calculating the position and time of the receiver is terminated, the method ends as shown in step 309.

A description of another embodiment of the invention will be now discussed. In this embodiment, it is assumed the case of a static receiver a receiver moving at a relatively low speed (<100 km/h) (that allows the receiver velocity to be approximated to zero) or a receiver that incorporates a sensor or sets of sensors that provide an estimation of the receiver's velocity, which is applied to the satellite-receiver Doppler estimation. This velocity can be determined from an inertial unit, odometer or any other suitable source or signal, thus reducing the number of Doppler measurements necessary to calculate said position and timing P1 and t1. As a person skilled in the art can appreciate, by not estimating the receiver velocity as part of the unknowns, the number of visible satellites can be reduced to at least five, or at least six if the measurement residuals are verified. In this static case, the proposed state vector to be solved is:

X=(x, y, z, f c, tc)

where x, y and z are the receiver coordinates (P1), fc is the receiver clock frequency drift, and tc is the time difference between the initial time t0 and the actual time t1. In this embodiment, the proposed system of equations is solved to estimate the state vector:

$$δ D = [ \begin{matrix}- {{e}^{′}}^{i} & 1 & {a}^{i}\end{matrix} ] [ \begin{matrix}δ x \\ δ y \\ δ z \\ δ fc \\ δ tc\end{matrix} ] + ɛ$$

Another embodiment of the present invention accounts for the case where the receiver altitude with respect to the Earth or any receiver position component is determined from another source, thus reducing the number of visible satellites necessary to compute said position and timing P1 and t1.

Another embodiment of the present invention accounts for the case where the receiver clock frequency drift fc is approximated to zero or determined from another source, thus reducing the number of Doppler measurements necessary to compute said position and timing P1 and t1.

Another embodiment of the present invention solves the problem where, under some circumstances when the time uncertainty period is too long and in the order of many hours, days, weeks or even months, the abovementioned system of equations may not converge to an adequate solution. This may be due to the linearization errors of non-linear equations, orbital repeatability or other causes. A solution to this problem is presented in FIG. 4. The method proposed in this embodiment consists of calculating a solution for several initial times. A way to implement this method is to split the time uncertainty interval into sub-intervals, define an initial time T0-i (T0-1, T0-2, T0-3, etc.) for each interval, and calculate a solution for each initial time. If the method converges to a plausible solution for a T0-i, the obtained measurement residuals, in case of an over-determined solution, will be below a certain threshold. The proposed embodiment calculates an indicator of the residuals magnitude for each solution P1 at T1-1, T1-2, etc., which can include the distance between the estimated height and the Earth surface as shown in FIG.4 (DOPPLER RESIDUALS), so as to determine whether the solution is plausible or not.

As shown in FIG.4 as a way of example, if the time uncertainty interval is too broad, there will be periods of non-convergence where an initial time T0-1, T0-4 is far from the correct time of the measurements t1 and the method does not converge to a plausible low-residual solution, and periods of convergence 404 where the initial time T0-2, T0-3 is close to the actual time and the method will converge to a plausible solution. These iterations with different initial times are performed in step 306 of FIG. 3.

As opposed to prior art cases where a solution needs to be computed at least every minute, with the proposed embodiment a single solution needs to be calculated for an interval of some hours, with a minimum of three hours and possibly more, depending on the satellite geometry, so that few iterations are needed to cover an uncertainty period of a day or several days, which can be calculated in few milliseconds in a standard processor embedded in a user receiver or in a server.

Another embodiment of the present invention solves the problem induced by the orbital repeatability of navigation satellite orbits, which lead to low-residual solutions (T1-5) below the residuals threshold (THR) at wrong times, as shown in FIG. 4. Due to this effect, a low residual solution can be obtained with a fixed periodicity, which is close to 12 hours in the case of GPS. To resolve this problem, this embodiment proposes that measurements from at least two satellites, each from a different satellite constellation like GPS, GLONASS, Galileo or Beidou, and with a different orbital period, are used to avoid the periodic repeatability of Doppler values from satellites from a single constellation leading to multiple plausible solutions. In this case, the Doppler repeatability period will correspond to the minimum common multiple of the orbital periods of the satellites used. Therefore, the proposed embodiment leads to a single low-residual solution over a period of several days (T1-2, T1-3). FIG.5 shows that only solutions including the correct time t1 will be accepted as plausible solutions, and the rest will be rejected as they will have residuals above the threshold (T1-5′).

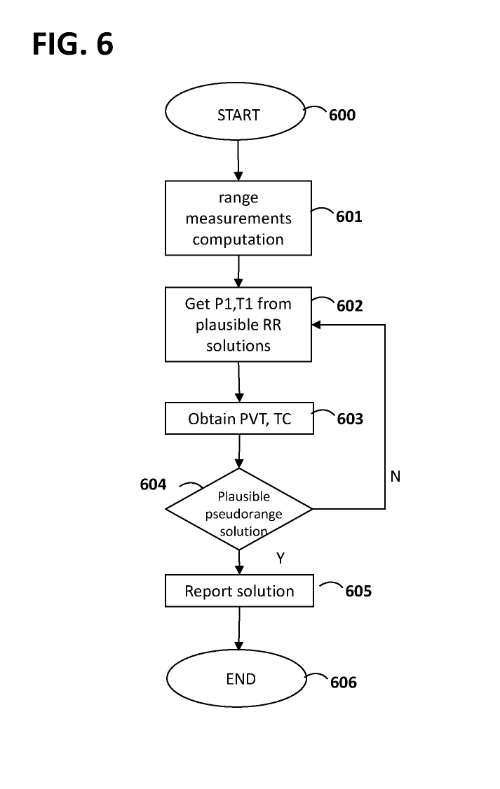

The method for another embodiment of the present invention is presented in FIG. 6. It accounts for the case where, after start 600, range measurements (also named code phase measurements), pseudorange or time-of-arrival measurements are obtained in step 601 and, in combination with initial solutions (P1, t1) 602 calculated as proposed in previous embodiments as the one shown in FIG.3. These range measurements are used to calculate a more accurate position, velocity and time (PVT) 603, or position and time. As a person skilled in the art may notice, methods to resolve the code phase integer ambiguity to compute a full range measurement from an instantaneous fractional range measurement without integer rollovers may be applied if necessary.

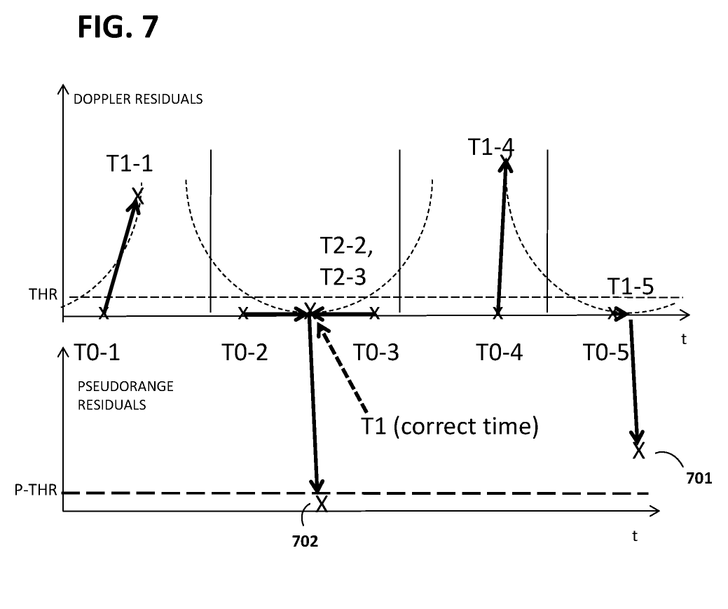

In the present embodiment, a coarse time navigation system of equations including a coarse time unknown (TC) as described in the prior art needs to be computed as depicted in step 603. The error expected with correct initial positions P1, t1 is generally in the order of a few kilometres and some milliseconds, allowing the convergence to a final solution with an accuracy of a few meters. According to previous embodiments, several solutions P1, t1 may be obtained and stored, as shown in FIG. 3, 307, from the Doppler method applied over a broad time uncertainty interval, as shown in FIG. 4 and FIG. 7, T1-5. In the case of an initial wrong solution associated to an initial wrong time T1-5, the analysis of the pseudorange solution measurement residuals, in a similar way as that proposed for previous embodiments but with a much lower threshold (P-THR) thanks to the higher accuracy of the pseudorange solution comparative with that of the Doppler solution as shown in FIG. 7, can be implemented. If the solution is incorrect, it will have a high-residual output 701 and will be discarded. If the solution is correct 702, it will have a low-residual output and it will be considered as correct. As a person skilled in the art will appreciate, an over-determined solution is required to generate an indicator of the measurement residuals, and the application of orbital and clock corrections to satellites at instants that differ by some hours or days to the correct time of applicability, will lead to positioning errors that will be reflected into a solution with higher residuals.

While the Doppler measurements can be generally obtained by measuring the carrier frequency of the signals, or the Doppler shift, as proposed in the description of the invention, another embodiment of the invention can be realised where the Doppler measurements are obtained from code phase difference between two measurements or carrier phase difference between two measurements at two time instants.

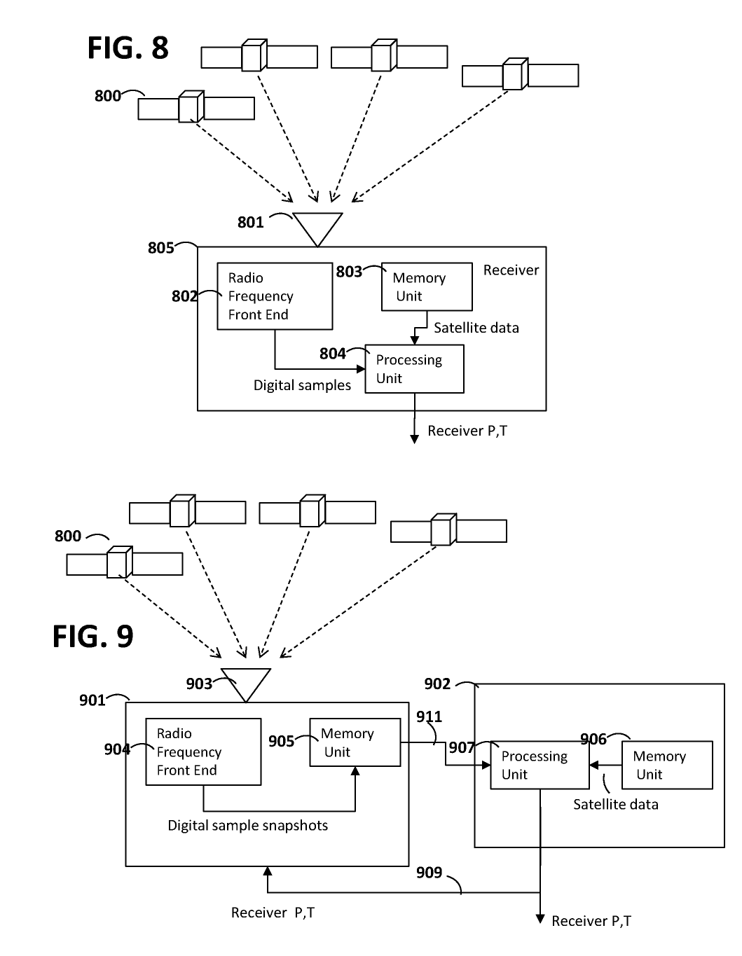

Another embodiment of the present invention relates to a system comprising an antenna 801, a receiver radio frequency front end 802, a memory unit 803 and a processing unit 804, as depicted in FIG. 8, aimed at calculating the receiver position and time without initial conditions, whereby:

said antenna 801 and front end 802 receive a radiofrequency signal stream containing the signals transmitted at least by one satellite 800 and converts it into a stream of digital samples;

said memory unit provides previously stored satellite position data, including at least information to calculate satellite positions;

said processing unit 804 processes the digital sample stream and estimates the satellite Doppler measurements and estimates at least one time reference t0, which can be arbitrarily taken or based on any synchronisation source, and which can differ from the actual measurement time in several days, weeks or months, and a position reference P0, which can be taken arbitrarily or based on any position on the Earth, Earth centre or satellite ground track points; and

said processing unit 804, for each pair of time reference (t0) and position reference (P0), estimates the position (P) and timing (T=t0+TC1) of said receiver with said Doppler measurements. This is performed by relating said Doppler measurements to a vector of unknowns that includes the satellite position, the satellite velocity, the receiver frequency clock drift and the coarse time difference (TC1) between said time reference t0 and the measurement time, as described in the methods of the previous embodiments.

Another embodiment of the present invention relates to a system as described in FIG. 9. In this embodiment, the antenna 903, receiver front end 904 and memory unit 905 are embedded in a portable localisation device or localisation unit 901, and the processing unit 907 is embedded in a server 902. Said localisation unit 901 generates and stores in the memory unit 905 one or several digital sample snapshots that are sent at any time to the server 902 equipped with another memory unit 906 and processing unit 907 through a communication channel 909 for determination of the position and time (Receiver P,T) of the localisation device, which can be returned back to said localisation unit 901 if necessary through said communication channel 909. This embodiment requires that both the localisation device and the server incorporate a wireless transceiver for transmitting the information required for the server to determine the position.

Another embodiment of the present invention accounts for the case where at least one digital snapshot of radiofrequency signal samples is stored in a memory unit 905 and the position and timing solution are calculated from this snapshot at a later stage.

Another embodiment of the present invention accounts for the case where the localisation device is powered up sporadically by a power unit in a way that said digital samples are not accurately time-tagged by the time reference of said localisation device 901 and the method of the present invention is used to calculate a time reference.

Another embodiment of the present invention accounts for the case where the localisation device 901 is embedded in a device that can be attached to or tagged to entities like animals, people or portable objects, or used for road tolling, allowing the location of said entities without said localisation device having an accurate time reference, and where the localisation unit 901 can integrate physical, motion or biometric sensors.

1. A method for calculating an actual time (t1) and an actual position (P1) of a radionavigation receiver (102, 805, 901) by using satellite radiofrequency signals, characterized in that the method comprises:
providing an initial receiver time (t0), an initial receiver position (P0) and satellite position data;
receiving said signals by said receiver (102, 805, 901) and computing from said received signals Doppler measurements between said satellites (103, 800) and said receiver (102, 805, 901);
estimating Doppler values (D(t0)) and Doppler change rates between said satellites (103, 800) and said receiver (102, 805, 901) at the initial receiver time (t0) and at the initial receiver position (P0) by means of said satellite position data;
computing Doppler values (D(t1)) between said satellites (103, 800) and said receiver (102, 805, 901) at the actual receiver time (t1);
calculating a time difference between the actual receiver time (t1) and the initial receiver time (t0) by computing a subtraction of the Doppler values (D(t0)) at the initial receiver time (t0) from Doppler values (D(t1)) at the actual receiver time (t1) and dividing said subtraction by the Doppler change rates; and
calculating the actual receiver position (P1) by means of the calculated actual receiver time (t1).

2. The method according to claim 1, wherein the steps of calculating the time difference and the actual receiver position (P1) are performed iteratively.

3. The method according to claim 1, wherein said initial receiver position (P0) is any arbitrary position on the Earth surface or the Earth centre or a position based on satellite ground track points at said initial receiver time (t0).

4. The method according to any of the preceding claims, wherein said Doppler measurements are computed from satellites (103, 800) with different orbital periods.

5. The method according to any of the preceding claims, wherein said Doppler measurements are obtained from said signals by computing the Doppler frequency shift or the code phase difference between two time instants or the carrier phase difference between two time instants.

6. The method according to any of the preceding claims, wherein the method further comprises computing range measurements and/or code phase measurements from said signals and estimating a final receiver time and a final receiver position by means of said measurements, wherein the measurements are initialised by the calculated actual receiver time (t1) and actual receiver position (P1).

7. The method according to any of the preceding claims, wherein the method further comprises computing a plurality of initial receiver times (t0) within a time uncertainty interval and calculating the actual receiver time (t1) and the actual receiver position (P1) for each of said initial receiver times (t0).

8. The method according to claim 7, wherein the method further comprises determining the validity of each calculated actual receiver time (t1) by means of an indicator based on the residuals of said measurements with respect to the calculated actual receiver position (P1).

9. The method according to claim 7, wherein the method further comprises determining the validity of each calculated actual receiver time (t1) by means of an indicator based on the height of the calculated actual receiver position (P1).

10. The method according to any of the preceding claims, wherein the steps of calculating the time difference and the actual receiver position (P1) are performed by relating said Doppler measurements to a vector of unknowns through a non-linear system of equations and solving the system of equations iteratively, wherein the vector includes a receiver position vector, a receiver velocity vector, a receiver frequency clock drift and a coarse time difference between the initial receiver time (t0) and the actual receiver time (t1).

11. The method according to claim 10, wherein at least one component of said vector is zero or is determined by an estimation of the height with respect to the Earth surface, an inertial unit, an odometer or an external time/frequency source.

12. A system for calculating an actual time (t1) and an actual position (P1) of a radionavigation receiver (102, 805, 901) by using satellite radiofrequency signals, characterized in that the system comprises a radionavigation receiver (102, 805, 901) and a plurality of satellites (103, 800), wherein:
said receiver (102, 805, 901) is adapted to receive said signals and to compute from said received signals Doppler measurements between said satellites (103, 800) and said receiver (102, 805, 901);
said receiver (102, 805, 901) is adapted to provide an initial receiver time (t0), an initial receiver position (P0) and satellite position data;
said receiver (102, 805, 901) is adapted to estimate Doppler values (D(t0)) and Doppler change rates between said satellites (103, 800) and said receiver (102, 805, 901) at the initial receiver time (t0) and at the initial receiver position (P0) by means of said satellite position data;
said receiver (102, 805, 901) is adapted to compute Doppler values (D(t1)) between said satellites (103, 800) and said receiver (102, 805, 901) at the actual receiver time (t1);
said receiver (102, 805, 901) is adapted to calculate a time difference between the actual receiver time (t1) and the initial receiver time (t0) by computing a subtraction of the Doppler values (D(t0)) at the initial receiver time (t0) from Doppler values (D(t1)) at the actual receiver time (t1) and dividing said subtraction by the Doppler change rates; and
said receiver (102, 805, 901) is adapted to calculate the actual receiver position (P1) by means of the calculated actual receiver time (t1).

13. The system according to claim 12, wherein said receiver (102, 805, 901) is further adapted to store at least one digital snapshot of samples of said signals and to calculate at least one actual receiver time (t1) and at least one actual receiver position (P1) at a scheduled time.

14. The system according to claim 13, wherein the system further comprises a server (902), the receiver (102, 805, 901) being further adapted to send said snapshot to the server, which server (902) is adapted to determine at least one actual receiver time (t1) and at least one actual receiver position (P1) according to the method in any of claims 1-11.

15. The use of a system according to any of claims 12-14 for road tolling or for tracking animals, people or portable objects.
